(19) United States
(12) Patent Application Publication
(10) Pub. No.: US 2010/0243724 A1
(43) Pub. Date: Sep. 30, 2010

(54) Payment Apparatus for a Personal Transportation System

(76) Inventor: Solomon K Golla, Columbus, OH (US)

Correspondence Address: Solomon K Golla, 4404 Keeler Dr., Columbus, OH, 43227, US

(21) Appl. No.: 12/414,340

(22) Filed: Mar. 30, 2009

(51) Int. Cl. G07B 13/04; G07B 15/00

(52) U.S. Cl. 235/30 R; 235/384

(57) ABSTRACT

A payment apparatus for a personal transportation system includes a display device for displaying a calculated fare for a passenger's desired travel. A card slot accepts a passenger's payment card for payment of the fare. A bill slot accepts paper currency for payment of the fare. A coin slot accepts coin currency for payment of the fare. A bill return returns paper currency as change for overpayment of the fare. A coin return returns coin currency as change for overpayment of the fare. A communicating means communicates to the personal transportation system that the fare has been paid.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to automobiles. More particularly, the invention relates to an automated taxi system.

### BACKGROUND OF THE INVENTION

The present invention relates to an automated driving system for carrying passengers. Catching a taxi can be time consuming and expensive. One needing a taxi currently must search the street for an available taxi or call a taxi service and wait for the taxi to arrive. Also, the portion of the fee that goes to pay the driver along with a tip can be costly. Prior art exists that enables an automobile to drive itself. It is therefore an objective of the present invention to provide a system that employs automobiles that can operate without drivers and respond to ride requests from customers to provide a less costly and more efficient taxi service.

In view of the foregoing, there is a need for improved techniques for providing a system for carrying passengers that can drive and take payment from passengers without a human operator.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a front view of an exemplary payment computer for an automated taxi service, in accordance with an embodiment of the present invention; and

FIG. 2 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a payment apparatus for a personal transportation system is presented.

In one embodiment, a payment apparatus for a personal transportation system is presented. The apparatus includes means for displaying a calculated fare for a passenger's desired travel, means for accepting a payment card for payment of the fare, means for accepting currency for payment of the fare, means for returning currency as change for overpayment of the fare and means for communicating to the personal transportation system that the fare has been paid.

In another embodiment a payment apparatus for a personal transportation system is presented. The apparatus includes a display device for displaying a calculated fare for a passenger's desired travel. A card slot accepts a passenger's payment card for payment of the fare. A bill slot accepts paper currency for payment of the fare. A coin slot accepts coin currency for payment of the fare. A bill return returns paper currency as change for overpayment of the fare. A coin return returns coin currency as change for overpayment of the fare. Communicating means communicates to the personal transportation system that the fare has been paid.

In another embodiment a payment computer for an automated taxi that operates in automated fashion to transport a passenger is presented. The payment computer includes a housing for mounting the payment computer in a passenger compartment of the automated taxi. A display device at least displays a calculated fare for a passenger's desired travel, current location and destination, the fare being at least calculated from distance and estimated time of travel for the passenger's desired travel. The display device is further configured for displaying advertisements and website type information. A card slot accepts a payment card where the passenger can insert a credit card or prepaid card for payment of the fare. A bill slot accepts paper currency where the passenger can insert bills for cash payment of the fare. A coin slot accepts coin currency where the passenger can insert coins for cash payment of the fare. A bill return returns paper currency as change for cash overpayment of the fare. A coin return returns coin currency as change for cash overpayment of the fare. Communicating means communicates to the automated taxi to begin the desired travel and that the fare has been paid where the automated taxi allows the passenger to exit at the destination.

Other features, advantages, and object of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide a taxi service with automobiles that can operate without human drivers. In typical use of a preferred embodiment, a customer calls the taxi service and tells the service where they are and where they want to go. In some embodiments the customer may contact the taxi service to schedule a ride using a website for the taxi service. Then, a dispatcher at the taxi service alerts the taxi about the call and sends the taxi to the location of the customer. When the taxi arrives, the customer pays a payment computer on the taxi. The taxi then drives the customer to the desired location.

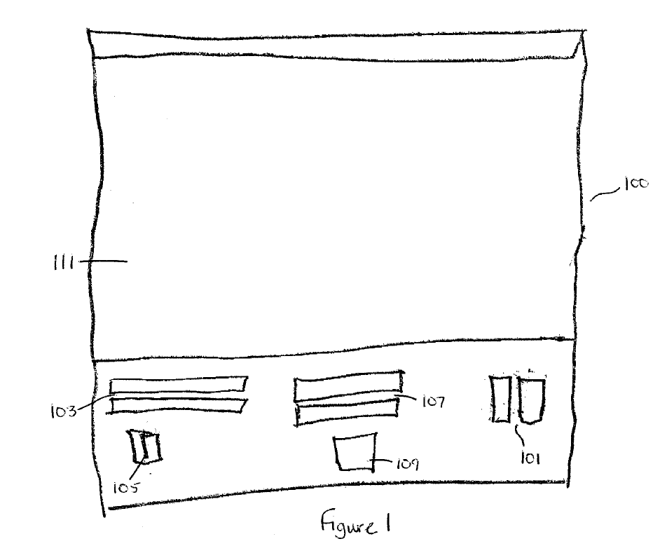

FIG. 1 is a front view of an exemplary payment computer 100 for an automated taxi service, in accordance with an embodiment of the present invention. In the present embodiment, payment computer 100 is located in front of the taxi passenger seat. The passenger must pay first with a credit card or cash before the taxi will take the passenger to the desired destination. Payment computer 100 is programmed to calculate the fare for the ride before reaching the passenger using parameters such as, but not limited to, distance and estimated time of travel. The passenger may pay with a credit card in a credit card slot 101, or the passenger may pay with cash by inserting bills into a bill slot 103 and coins into a coin slot 105. If the passenger requires change when paying cash, the change is dispensed from a bill return 107 and a coin return 109. Those skilled in the art, in light of the present teachings, will readily recognize that payment computers may have various different features and the fares may be collected in various different ways in alternate embodiments. For example, without limitation, in some embodiments the payment computer may be able to read a fare card with a magnetic strip or barcode onto which the passenger may preload value. In some embodiments the payment computer may be located in different places such as, but not limited to, in the dash or on the passenger door. In embodiments where the payment computer is on the door, the passenger must pay before getting in the taxi. In the present embodiment, a screen 111 displays information to the passenger including, but not limited to, the fare required, the destination, current location, advertisements, etc. In some embodiments the computer screen may display the website of the taxi company or other types of websites.

In a non-limiting example illustrating the typical use of the present embodiment, a customer calls a taxi company and tells the dispatcher where he would like to go and where he would like to be picked up. For example, without limitation, the customer tells the dispatcher that he is at 4536 Book Rd and that he would like to go to 9678 Lake Rd. The dispatcher tells the customer that the taxi will be there in ten minutes. The dispatcher tracks the locations of all of the taxis in his fleet, for example, without limitation, using GPS. The dispatcher contacts the closest available taxi to the location of the customer and programs the automated driving system of the taxi with the customer location and desired destination. Payment computer 100 uses this information to calculate the fare for the ride. The taxi drives to the customer location and the fare amount is displayed to the customer on screen 111. The customer pays using credit card slot 101 or bill slot 103 and coin sot 105. If payment computer 100 is located in front of the passenger seat, the taxi begins driving the customer to the desired destination once he has paid. If payment computer 100 is located on the door, the door of the taxi opens once the customer pays, and if the customer pays cash, any change owed to the customer is dispensed from bill return 107 and coin return 109 before the door opens. Once the customer is inside the taxi, the taxi drives him to his destination. Some embodiments may comprise a button on the payment computer that enables the customer to tell the taxi to begin driving. This generally ensures that the customer is ready to go before the taxi starts driving. In some cases in order to save time, the customer may schedule a ride in advance. For example, without limitation, a customer needing to go to the airport may call the service the night before to schedule a ride for the following morning. In this non-limiting example, a taxi arrives at the customer location at the scheduled time to take the customer to the airport.

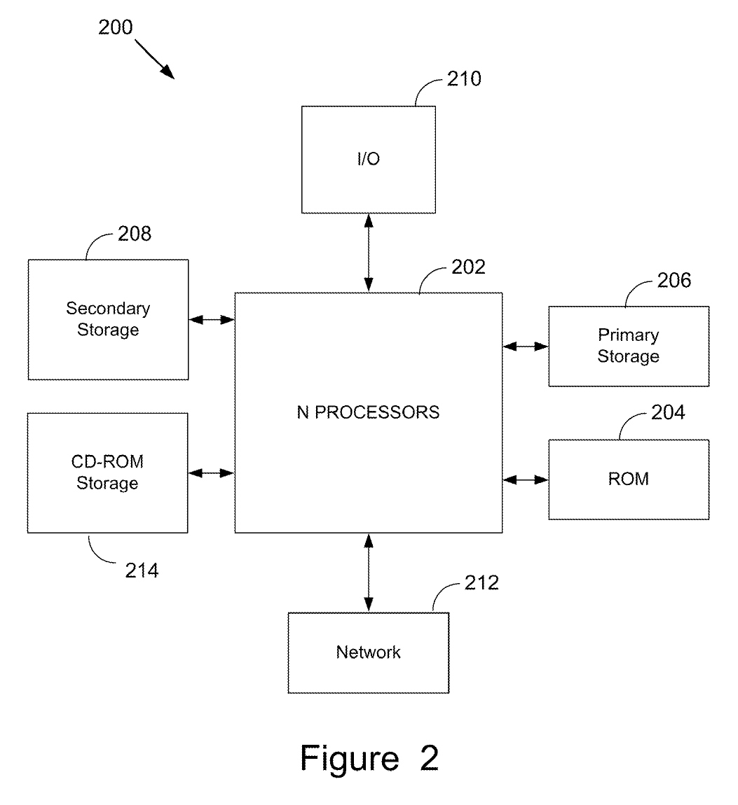

FIG. 2 illustrates a typical computer system that, when appropriately configured or designed, can serve as a computer system in which the invention may be embodied. The computer system 200 includes any number of processors 202 (also referred to as central processing units, or CPUs) that are coupled to storage devices including primary storage 206 (typically a random access memory, or RAM), primary storage 204 (typically a read only memory, or ROM). CPU 202 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 204 acts to transfer data and instructions uni-directionally to the CPU and primary storage 206 is used typically to transfer data and instructions in a bi-directional manner. Both of these primary storage devices may include any suitable computer-readable media such as those described above. A mass storage device 208 may also be coupled bi-directionally to CPU 202 and provides additional data storage capacity and may include any of the computer-readable media described above. Mass storage device 208 may be used to store programs, data and the like and is typically a secondary storage medium such as a hard disk. It will be appreciated that the information retained within the mass storage device 208, may, in appropriate cases, be incorporated in standard fashion as part of primary storage 206 as virtual memory. A specific mass storage device such as a CD-ROM 214 may also pass data uni-directionally to the CPU.

CPU 202 may also be coupled to an interface 210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 202 optionally may be coupled to an external device such as a database or a computer or telecommunications or internet network using an external connection as shown generally at 212, which may be implemented as a hardwired or wireless communications link using suitable conventional technologies. With such a connection, it is contemplated that the CPU might receive information from the network, or might output information to the network in the course of performing the method steps described in the teachings of the present invention.

Having fully described at least one embodiment of the present invention, other equivalent or alternative methods of providing an automated taxi service according to the present invention will be apparent to those skilled in the art. The invention has been described above by way of illustration, and the specific embodiments disclosed are not intended to limit the invention to the particular forms disclosed. For example, the particular implementation of the passenger carrying system may vary depending upon the particular type of vehicle used. The vehicles described in the foregoing were directed to taxi implementations; however, similar techniques are to provide passenger carrying systems using different vehicles such as, but not limited to limousines, buses, handicap accessible vehicles, small electric vehicles, etc. Non-taxi implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A payment apparatus for a personal transportation system, the apparatus comprising:
means for displaying a calculated fare for a passenger's desired travel;
means for accepting a payment card for payment of the fare;
means for accepting currency for payment of the fare;
means for returning currency as change for overpayment of the fare; and
means for communicating to the personal transportation system that the fare has been paid.

2. A payment apparatus for a personal transportation system, the apparatus comprising:
a display device for displaying a calculated fare for a passenger's desired travel;
a card slot for accepting a passenger's payment card for payment of the fare;
a bill slot for accepting paper currency for payment of the fare;
a coin slot for accepting coin currency for payment of the fare;
a bill return for returning paper currency as change for overpayment of the fare;
a coin return for returning coin currency as change for overpayment of the fare; and
means for communicating to the personal transportation system that the fare has been paid.

3. The apparatus as recited in claim 2, wherein the communicating means further communicates to the transportation system to start the passenger's desired travel.

4. The apparatus as recited in claim 2, wherein the communicating means further communicates to the transportation system to allow the passenger to exit upon completion to the passenger's desired travel.

5. The apparatus as recited in claim 2, wherein the display device further displays websites.

6. The apparatus as recited in claim 2, wherein said payment card is a credit card.

7. The apparatus as recited in claim 2, wherein said payment card is a prepaid fare card.

8. The apparatus as recited in claim 2, wherein the display device further displays advertisements.

9. The apparatus as recited in claim 2, wherein the transportation system comprises an automated taxi system and the communication means communicates with the automated taxi system.

10. A payment computer for an automated taxi that operates in automated fashion to transport a passenger, the payment computer comprising:
a housing for mounting the payment computer in a passenger compartment of the automated taxi;
a display device for at least displaying a calculated fare for a passenger's desired travel, current location and destination, the fare being at least calculated from distance and estimated time of travel for the passenger's desired travel, the display device further being configured for displaying advertisements and website type information;
a card slot for accepting a payment card where the passenger can insert a credit card or prepaid card for payment of the fare;
a bill slot for accepting paper currency where the passenger can insert bills for cash payment of the fare;
a coin slot for accepting coin currency where the passenger can insert coins for cash payment of the fare;
a bill return for returning paper currency as change for cash overpayment of the fare;
a coin return for returning coin currency as change for cash overpayment of the fare; and
means for communicating to the automated taxi to begin the desired travel and that the fare has been paid where the automated taxi allows the passenger to exit at the destination.
